(19) United States
(12) Patent Application Publication
(10) Pub. No.: US 2008/0001856 A1
(43) Pub. Date: Jan. 3, 2008

(54) DRIVING OLED DISPLAY WITH IMPROVED UNIFORMITY

(75) Inventor: Ronald S. Cok, Rocester, NY (US)

Correspondence Address: EASTMAN KODAK COMPANY;PATENT LEGAL STAFF, 343 STATE STREET, ROCHESTER, NY, 14650-2201, US

(73) Assignee: Eastman Kodak Company

(21) Appl. No.: 11/427,514

(22) Filed: Jun. 29, 2006

(51) Int. Cl. G09G 3/30

(52) U.S. Cl. 345/76

(57) ABSTRACT

A method of driving an OLED display having a plurality of light-emitting display elements having outputs that change with time or use, comprising the steps of: a) providing an external image signal with a first image aspect ratio; b) providing an OLED display having light-emitting display elements formed in a two-dimensional array having a second display aspect ratio different from the first image aspect ratio; c) driving all of the two-dimensional array of display elements with a composite signal comprising the external image signal and an internal aging signal, wherein a subset of the display elements is driven by the external image signal and the remainder of the display elements that are not driven by the external image signal are driven with the internal aging signal; and d) changing the location of the subset of display elements within the two-dimensional array driven by the external image signal over time.

### FIELD OF THE INVENTION

The present invention relates to solid-state OLED flat-panel display devices and more particularly to methods for driving such display devices to reduce differential aging of the organic light-emitting display and provide improved display uniformity.

### BACKGROUND OF THE INVENTION

Solid-state organic light-emitting diode (OLED) image display devices are of great interest as a superior flat-panel display technology. These displays utilize current passing through thin films of organic material to generate light. The color of light emitted and the efficiency of the energy conversion from current to light are determined by the composition of the organic thin-film material. Different organic materials emit different colors of light. However, as the display is used, the organic materials in the device age and become less efficient at emitting light. This reduces the lifetime of the display. The differing organic materials may age at different rates, causing differential color aging and a display whose white point varies as the display is used. If some light-emitting elements in the display are used more than other, spatially differentiated aging may result, causing portions of the display to be dimmer than other portions when driven with a similar signal.

OLED devices can employ a variety of light-emitting organic materials patterned over a substrate that emit light of a variety of different frequencies, for example red, green, and blue, to create a full-color display. Referring to FIG. 4, a graph illustrating the typical light output of an OLED display device as current is passed through the OLEDs is shown. The three curves represent typical performance of the different light emitters emitting differently colored light (e.g. red, green and blue light emitters, respectively) as represented by luminance output over time or cumulative current. As can be seen by the curves, the decay in luminance between the differently colored light emitters can be different. The differences can be due to different aging characteristics of materials used in the differently colored light emitters, or due to different usages of the differently colored light emitters. Hence, in conventional use, with no aging correction, the display will become less bright and the color, in particular the white point, of the display will shift. Moreover, patterned deposition is difficult, requiring, for example, expensive metal masks. Alternatively, it is known to employ a combination of emitters, or an unpatterned broad-band emitter, to emit white light together with patterned color filters, for example red, green, and blue, to create a full-color display. The color filters may be located on the substrate, for a bottom-emitter, or on the cover, for a top-emitter. For example, U.S. Pat. No. 6,392,340 entitled “Color Display Apparatus Having Electroluminescence Elements” issued May 21, 2002 illustrates such a device. Such designs are useful because they do not suffer from differential color aging although they are still susceptible to differential aging due to different usage of different areas in the OLED display. In particular, this occurs when the screen displays a single graphic element in one location for a long period time. Such graphic elements can include stripes or rectangles with background information, for example such as news headlines and sports scores, network logos, and the like. Differences in signal format are also problematic.

All televisions utilize a display device to transform video information into light. This is typically accomplished through the use of electronic controls that convert the video information into control signals that operate the display device. However, display devices may vary in their size, resolution, and aspect ratio, among other characteristics. Likewise, the video information format, resolution, and aspect ratio may vary. Hence, the video information provided to a television may not correspond to the characteristics of the display device used in the television or other display device. In particular, the aspect ratio of the video information may not match the aspect ratio of the display.

This problem typically arises when video signals formatted with one aspect ratio are displayed on a television with a display device having a different aspect ratio. The aspect ratio of a television picture image is a ratio of horizontal length to vertical length, expressed in relative units. Standard video signals, such as NTSC and PAL video signals, are formatted with a 4:3 aspect ratio (i.e., 1.33 aspect ratio), whereas non-standard video signals, such as HDTV video signals, are formatted with an aspect ratio greater than the standard 4:3 aspect ratio. For example, an HDTV video signal is typically formatted with a 16:9 aspect ratio (i.e., 1.77 aspect ratio). Modern cinematographic theater movies, not made expressly for conventional television, are typically films with aspect ratios greater than 1.33, typically ranging between 1.65 and 2.35.

When standard video signals are displayed on a standard television screen (i.e., a television screen having a 1.33 aspect ratio), the picture image appears on the entire television screen. As long as these standard video signals are displayed on a standard television screen, the display device is illuminated over the entire viewing area of the display. When a non-standard video signal, such as an HDTV video signal, is displayed on a standard television screen, a region of the display that would normally be illuminated in response to a standard video signal is not illuminated in response to the non-standard video signal. As a result, e.g., the picture image appears on the middle horizontal region of the television screen and black (non-illuminated) bars appear on the respective top and bottom horizontal regions of the television screen. Likewise, television screens having a 16:9 aspect ratio will illuminate the central portion of the display and have black bars on either side of the display in response to a standard video signal.

For example, referring to FIG. 5, a first display device 100 has a first screen aspect ratio of 4:3 and displays a video signal having the same aspect ratio to illuminate a region 105 comprising the entire display area of the first display device 100. In this case, the external video signal is suited to the display device. Referring to FIG. 6, a second display device 102 has a second screen aspect ratio 16:9 and displays an external video signal having the same aspect ratio to illuminate a region 107 comprising the entire display area of the second display device 102. Again, in this second case, the external video signal is suited to the second display device. However, referring to FIG. 7, in a third case if the first display device 100 receives a video signal having a different aspect ratio of 16:9, regions 104 of the display are not illuminated while region 105 is illuminated. Similarly, referring to FIG. 8, in a fourth case if the second display device 102 receives an external video signal having a different aspect ratio of 4:3, regions 106 of the display are not illuminated while the region 107 is illuminated.

For some display devices, illumination of one portion of a display device only does not have an effect on the display device. For example liquid crystal devices use a backlight to illuminate the entire viewing area of the display even if only a portion of the display has information. In this case, the light illuminating the region of the display that has no information is blocked by the liquid crystals. For other display devices such as OLEDs or plasma displays, however, illuminating one region of a display and not others for any significant period of time results in differential aging such that the illuminated area is aged and the dark areas are not. When a standard video signal is then displayed on a standard television screen on which non-standard video signals have been displayed over an extended period of time, the top and bottom horizontal regions of the television screen as illustrated in FIG. 7 will be distinctly brighter than the middle horizontal region of the television screen. A similar phenomenon occurs when a standard video signal is displayed on a non-standard television screen for an extended period of time (as illustrated in FIG. 5), causing the middle vertical region of the nominal scanning area of the display appear darker than the respective left and right vertical regions of the display. This differential aging phenomenon results in visible artifacts when the display is uniformly illuminated. Most viewers will complain about this phenomenon.

This problem has been addressed for televisions using a cathode ray tube display. U.S. Pat. No. 6,359,398 B1 entitled “Method to control CRT phosphor aging” issued Mar. 19, 2002 describes methods and apparatus that are provided for equally aging a cathode ray tube (CRT). A video input terminal is coupled to the CRT and receives an external video signal. Control circuitry is provided, which detects the aspect ratio of the signal and determines whether there is a mismatch between the signal aspect ratio and an aspect ratio of a display screen in association with the CRT. If a mismatch between the signal aspect ratio and the screen aspect ratio exists, an equalization video signal is derived from the external video signal. A primary region of the CRT is illuminated in response to the external video signal, and a secondary region of the CRT, which would otherwise be unilluminated in response to the external video signal due to the mismatch between the signal aspect ratio and the screen aspect ratio, is illuminated in response to the equalization video signal. In this manner, the CRT is uniformly aged. However, the solution proposed requires the use of blocking means such as doors or covers that may be manually or automatically provided to shield the non-illuminated areas from view when the equalization video signal is applied to the otherwise non-illuminated region of the display. This solution is unlikely to be acceptable to most viewers because of the cost and inconvenience. U.S. Pat. No. 6,359,398 also discloses that secondary regions may be illuminated with gray video having luminance intensity matched to an estimate of the average luminous intensity of the program video displayed in the primary region. As indicated therein, however, such estimation is not perfect, resulting in a reduced, but still present, non-uniform aging. U.S. Pat. No. 6,369,851 entitled “Method and Apparatus to Minimize Burn Lines in a Display” issued Apr. 9, 2002 describes a method and apparatus for displaying a video signal using an edge modification signal to reduce spatial frequency and minimize edge burn lines, and/or a border modification signal to increase brightness of image content in a border area of a displayed image, where the border area corresponds to a non-image area when displaying images with a different aspect ratio. However, these solutions may cause objectionable image artifacts, for example reduced sharpness or visibly brighter border areas in displayed images.

The general problem of regional brightness differences due to icon burn-in of specific areas due to video content has been addressed in the prior art, for example by U.S. Pat. No. 6,856,328 B2 entitled, “System and method of displaying images” Logos may be present in images transmitted by television stations. These logos are often present in the corners of an image for a long time. They do not move and may comprise saturated colors. This results in burn-in effects in emissive displays because the logos provide the same display load at the same location for a relatively long period of time. The burn-in effect can be prevented by detecting the logos in the corners of the image and reducing their intensity to the average display load. This method requires the detection of static areas and may not prevent color-differentiated burn-in. An alternative technique is described in JP2005037843 A entitled “Camera and Display Control Device”. In this disclosure, a digital camera is provided with an organic EL display that is prevented from sticking (burning in) by employing a DSP in the digital camera. The DSP changes the position of an icon on the organic EL display by changing the position of the icon image data in a memory every time that the camera is started. Since the degree to which the display position is changed is approximately one pixel a user cannot recognize the change in the display position. However, this approach requires a prior knowledge and control of the image signal and does not address the problem of format differences.

US2005/0204313 describes a further method for display screen burn prevention, wherein an image is gradually moved in an oblique direction in a specified display mode. Similarly, commercial plasma television products advertise pixel orbiter operational modes that sequentially shifts the image three pixels in four directions according to a user-adjustable timer. However, these techniques may not employ all pixels of a display, and therefore may create a border effect of pixels that are brighter than those pixels in the image area that are always used to display image data.

Accordingly, there is a need for an improved method and apparatus for reducing non-uniformities in a display device.

### SUMMARY OF THE INVENTION

In accordance with one embodiment, the invention is directed towards a method of driving an OLED display having a plurality of light-emitting display elements having outputs that change with time or use, comprising the steps of:

a) providing an external image signal with a first image aspect ratio;

b) providing an OLED display having light-emitting display elements formed in a two-dimensional array having a second display aspect ratio different from the first image aspect ratio;

c) driving all of the two-dimensional array of display elements with a composite signal comprising the external image signal and an internal aging signal, wherein a subset of the display elements is driven by the external image signal and the remainder of the display elements that are not driven by the external image signal are driven with the internal aging signal; and

d) changing the location of the subset of display elements within the two-dimensional array driven by the external image signal over time.

### ADVANTAGES

The advantages of this invention include providing an OLED display device that reduces differential aging of the organic materials in the display when displaying images with aspect ratios not matched to the display without requiring extensive or complex circuitry.

### BRIEF DESCRIPTION OF THE DRAWINGS

FIG. 1 is a flow diagram of a method according to one embodiment of the present invention;

FIG. 2 is a schematic diagram illustrating a display useful in carrying out the method of the present invention;

FIG. 3A is a schematic diagram illustrating an array of light-emitting elements and various high-definition format subsets of light-emitting elements according to various embodiments of the present invention;

FIG. 3B is a schematic diagram illustrating an array of light-emitting elements and various standard-definition format subsets of light-emitting elements according to various embodiments of the present invention;

FIG. 4 illustrates the lifetime of typical OLED materials;

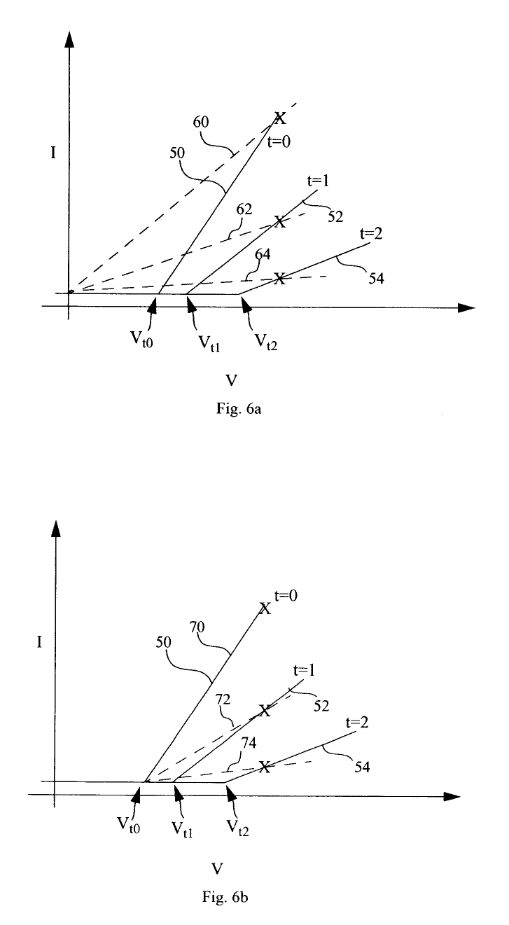

FIGS. 5-9 are diagrams illustrating groups of light-emitting elements in various standard and high-definition formats.

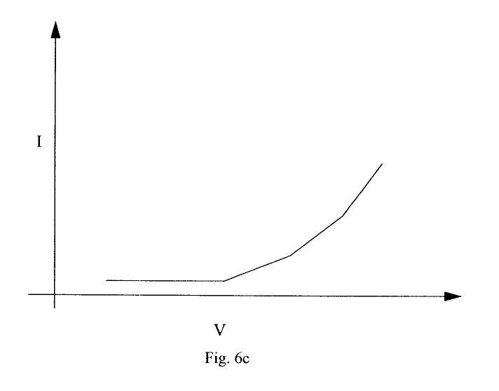

### DETAILED DESCRIPTION OF THE INVENTION

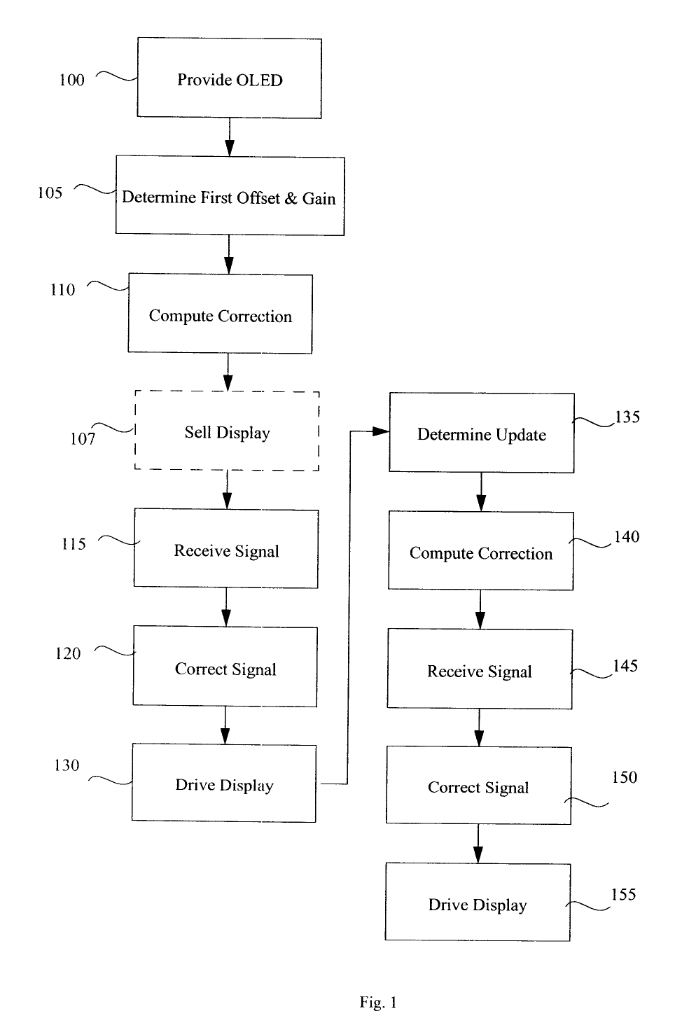

Referring to FIG. 1, a method of driving an OLED display having a plurality of light-emitting display elements having outputs that change with time or use, comprises the steps of providing 200 an external image signal with a first image aspect ratio; providing 202 an OLED display having light-emitting display elements formed in a two-dimensional array having a second display aspect ratio different from the first image aspect ratio; driving 204 all of the two-dimensional array of display elements with a composite signal comprising the external image signal and an internal aging signal, wherein a subset of the display elements is driven by the external image signal and the remainder of the display elements that are not driven by the external image signal are driven with the internal aging signal; and changing 220 the location of the subset of display elements within the two-dimensional array driven by the external image signal over time. The composite signal may be formed 212 in a variety of ways using techniques known in the prior art, for example by digitizing 206 and storing 208 the external image signal in a memory having a size of the two-dimensional array of display elements at the desired address locations in the memory, forming 210 an internal aging signal by writing a signal value into the memory address locations that do not store the digitized external image signal values, and reading out 214 the entire memory through a digital to analog convertor to the display. Other means for forming the composite signal may employ analog techniques relying on switching between the external image signal and the internal aging signal to write the external image signal and the internal aging signal to the appropriate locations on the OLED display.

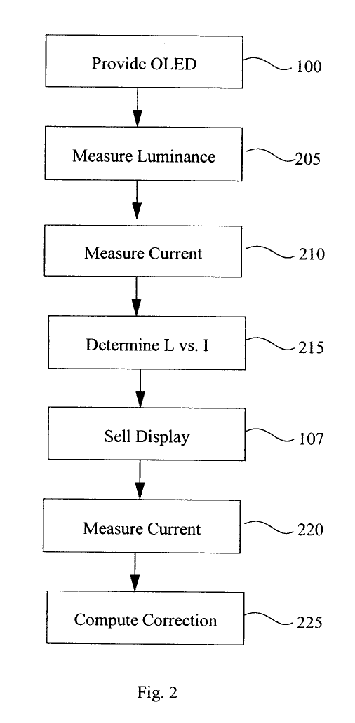

Referring to FIG. 2, in accordance with a further embodiment of the invention, an OLED display 10 includes a plurality of light-emitting display elements 12 having outputs that change with time or use. Controller 16 receives an external image signal 18 with an image aspect ratio different from the display 10 aspect ratio, and drives all of the two-dimensional array of display elements 12 with a composite signal 20 comprising the external image signal 18 and an internal aging signal 19. A subset of the display elements 12 is driven by the external image signal 18 and the remainder of the display elements 12 that are not driven by the external image signal 18 are driven with the internal aging signal 19. Controller 16 also changes the location of the subset of display elements within the two-dimensional array driven by the external image signal 18 over time. The change in subset location may preferably be very slow, possibly once per hour or even once per operating cycle (i.e. each time the display is powered up) so that the change in subset is indiscernible to a viewer. The change in location of the subset may be as large as perceptually acceptable, within the boundaries of the two-dimensional array of display elements. Minimally, the change in location may be as small as a shift in one dimension or another, or both, by a single pixel.

Because the aspect ratio of the display and the external image signal are different and, according to the present invention not all of the display elements 12 are driven by the external image signal 18 at the same time, the number of display elements 12 in the subset of the display elements is smaller than the total number of display elements 12 in at least one dimension of the two-dimensional array of display elements 12. In a further embodiment of the present invention, the number of display elements 12 in the subset of the display elements may be smaller than the total number of display elements 12 in each dimension of the two-dimensional array of display elements 12. Moreover, the number of light-emitting display elements 12 in the two-dimensional array may be larger than the number of image elements in each corresponding dimension of the external image signal 18.

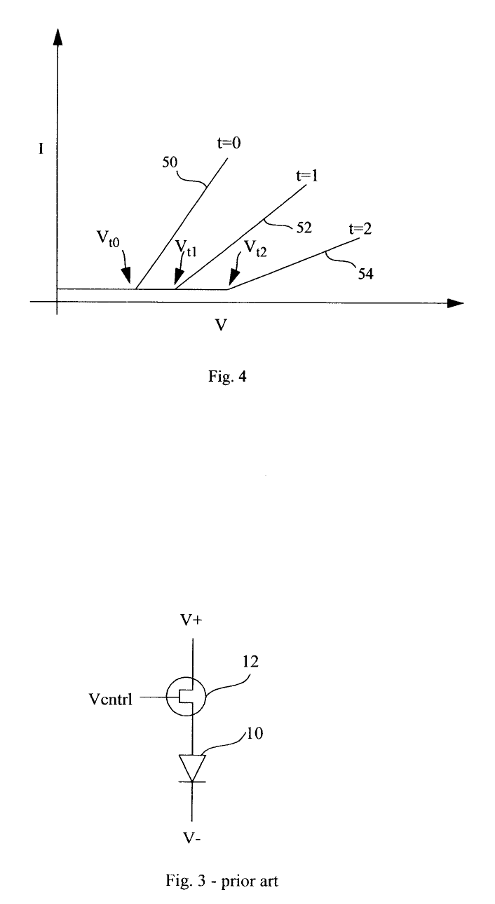

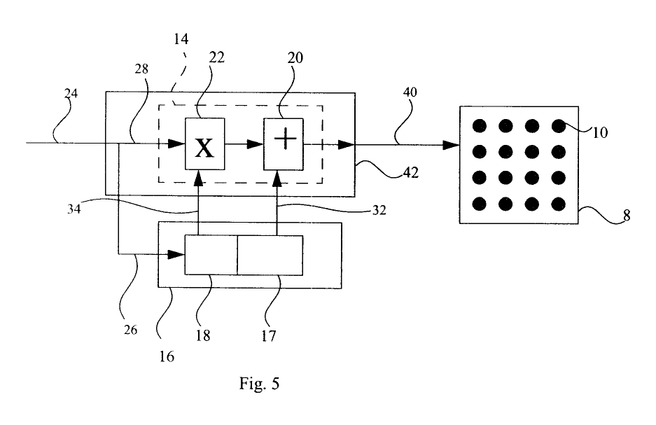

The present invention is particularly useful for OLED display devices that display both high-definition television or standard definition television format signal and the aspect ratios may correspond to the aspect ratios of these standards. A standard definition television format signal has an aspect ratio of 4:3 whereas a high-definition television format signal has an aspect ratio of 16:9. Referring to FIG. 3A, a subset 30 of an array of light-emitting display elements 12 in display 10 has a border 40a, 40b of three light-emitting element in both dimensions. In this embodiment, the subset 30 of light-emitting display elements 12 specifies a high-definition format (16:9). At a given time, the subset 30 of light-emitting display elements 12 may display the external image signal 18. All other light-emitting elements 12 that are not within subset 30, i.e. those light-emitting elements 12 in the borders 40a and 40b, are driven with the internal aging signal 19. Over time, the controller 16 changes the location of the subset 30 to a different location, for example 30′, and drives the light-emitting display elements 12 in the subset 30′ with the external image signal 18. Once again, the remaining light-emitting display elements 12 that are not within subset 30′ are driven with the internal aging signal 19.

Referring to FIG. 3B, the display 10 of FIG. 3A is shown with a subset 32 of light-emitting display elements 12 specifying a standard-definition format (4:3). At a given time, the subset 32 of light-emitting display elements 12 may display the external image signal 18. All other light-emitting display elements 12 that are not within subset 32, i.e. those light-emitting display elements 12 in the borders 42a and 42b, are driven with the internal aging signal 19. Note that in this case the borders 42a and 42b are not of equal size. Because the display 10 is of approximately high-definition aspect ratio and the external image signal 18 is a standard-definition signal, the borders 42b on either side are wider than the borders 42a on the top and bottom. Over time, the controller 16 changes the location of the subset 32 to a different location, for example 32′, and drives the light-emitting display elements 12 in the subset 32′ with the external image signal 18. Once again, the remaining light-emitting display elements 12 that are not within the subset 32′ are driven with the internal aging signal 19. In this embodiment of the present invention, it may be preferred to set limits on the locations of the subsets 32, 32′. Because the border 42b on either side are much greater than the borders 42a above and below, a user may perceive that the external image signal 18 is not symmetrically located in the center of the display 10. Hence, limits 44a and 44b may be applied to limit the subset locations to subset groups that fall between the limits.

According to the present invention, the light-emitting display elements 12 have outputs that change with time or use. If any light-emitting display elements 12 display a brighter or dimmer signal, for example logos, headlines, box scores, etc., for a lengthy period of time, the light-emitting display element 12 will be darker or brighter compared to neighboring light-emitting elements when they are all illuminated with a signal specifying a common brightness. Hence, the light-emitting elements that are driven by the external display signal 18 will become less bright over time. According to the present invention, the light-emitting display elements 12 that are not driven by the external image signal 18 are driven by an internal aging signal 19.

Internal aging signal 19 may, e.g., be set to drive the remaining light-emitting display elements (i.e., those that are not driven by the external image signal 18) at the average luminance of the external image signal 18. While such embodiment may provide the minimum differential aging, Applicants have determined through experimentation that simply driving the internal aging signal 19 at the average of the external image signal 18 provides an unacceptable dynamic variation in the display borders that may be very distracting. Employing the expected average brightness of a series of external image signal scenes over time may reduce the dynamic variation, but still leaves room for inaccuracies based on the presumed average brightness. Hence, an alternative internal aging signal value may be desired.

Applicants have also determined that, in some circumstances, a border that is darker than the average luminance of the external image signal 18 may be desired, particularly when a displayed scene content is darker than the average luminance of displayed scene contents over time. Hence, in various embodiments of the present invention, the internal aging signal may have a luminance value of 90% or less of the average luminance value of the external image signal over time, and more preferably 75% or less of the average luminance value of the external image signal over time. At the same time, it is necessary that the internal aging signal have sufficient brightness to effectively age the border pixels and reduce differential aging. Hence, in various embodiments of the present invention, the internal aging signal also may have a luminance value of at least 10% of the average luminance value of the external image signal over time, and more preferably at least 25% of the average luminance value of the external image signal over time. In a more specific embodiment, the internal aging signal may have a luminance value approximately 50% of the average luminance value of the external image signal over time.

Because reducing the internal aging signal to a value less than the average external signal value over time will result in less aging of the border pixels, absent countervailing measures a difference in brightness may eventually be perceived between the subset and border pixels. According to the present invention, however, the location of the external image signal values in the display is changed over time. This change will reduce the spatial frequency of any differential aging effect. Since the human eye is less sensitive to low-frequency changes in luminance than to high-frequency changes in luminance, a more pleasing viewing environment is provided. The magnitude of the changes in location will determine the extent of the spatial frequency reduction of the artifacts resulting from differential aging. Note that, unlike some other prior-art proposals, this technique does not reduce the spatial frequency of the scene content itself.

In some embodiments of the present invention, the internal aging signal 19 may be dependent upon a portion of the external image signal, for example the internal aging signal may be limited to the average luminance value of a portion of the external image signal, changing dynamically as the external image signal changes or averaged over time. The portion may correspond to edges of the display that are formed by display elements driven by the internal aging signal rather than the external image signal. In yet another embodiment, the internal aging signal may combine elements of various signals, for example the internal aging signal may be limited to driving light-emitting elements 12 to the smaller of the average scene luminance over time and the minimum luminance of a border of the external image signal scenes. By combining these limitations, a more acceptable user viewing experience and a higher image quality may be obtained. In an alternative embodiment of the present invention, the internal aging signal may depend upon the relative amount of time that the light-emitting elements are driven with the external image signal or on the average luminance of the external image signal over time. Since display elements that are driven for some of the time with the external image signal and some of the time with an internal aging signal may age at different rates, the aging signal may be adapted to consider the relative amount of time display elements are driven by the different signals.

Referring to FIG. 9, some video recordings are intended for playback on a display having a different aspect ratio than the source video content. In such recordings, a border 100 may be added to the edges of the video content 107 to form a reformatted video image signal having a format different than the content. Since a dark border is typically employed, pixels displaying the border area 100 will not be aged at the same rate as those displaying the central portion of the video content 107 of the reformatted video image signal. Where the present invention is employed to display such a reformatted video image signal in a subset of display elements on a display having an aspect ratio different from that of the reformatted video image signal, the display controller may sample the video content to determine if it has been reformatted. If so, the border areas of the reformatted video signal may be likewise driven with an internal aging signal to match the area 106 of the display elements not driven by the reformatted video signal.

It is not necessary that all of the light-emitting display elements 12 driven by the internal aging signal 19 be illuminated identically. In other embodiments of the present invention, light-emitting display elements 12 driven by the internal aging signal 19 adjacent to the light-emitting elements driven by the external image signal 18 may be driven at a level lower than those farther away, to increase the contrast at the edge of the external display image scene.

Alternatively, the light-emitting display elements 12 driven by the internal aging signal 19 adjacent to the light-emitting elements driven by the external image signal 18 may be driven at a level that combines the external image signal 18 adjacent to the border values with some other value, for example the average or minimum scene value. In this way, the differential aging effect caused by any structures at the edge of a scene may be mitigated. For example, the light-emitting display elements 12 in the border and adjacent to the light-emitting elements 12 driven by the external image signal 18 may be driven to a level that is an interpolated value of the adjacent light-emitting display elements 12 driven by the external image signal 18 and an average brightness. In this embodiment, the internal aging signal depends on the average brightness of a portion of the external image signal over time. In an alternative embodiment, the display elements 12 adjacent to a border may have a reduced luminance so that the transition from display elements that are driven by the external image signal to display elements driven by a less-bright internal aging signal is more gradual and visually appealing.

In an alternative embodiment of the present invention, the internal aging signal may be set to correspond to a fraction of the maximum display luminance. Since displays are typically calibrated to emit light at a particular maximum luminance level, this calibration setting can also be used to determine the internal aging signal luminance. This approach obviates the need to measure or consider the brightness of an external image signal.

External research on television scene content has established that that average luminance of broadcast scenes over time may be no more than 12% of the maximum brightness of a series of scenes. Other estimates range up to 18% or 20%. Hence, the border light-emitting elements may be driven to those levels to provide an aging effect comparable to the aging effect of external image signal 18. In such embodiments, the internal aging signal may be dependent on the relative amount of time that the light-emitting elements are driven with the external signal or the relative brightness of the external signal or both. Applicants have created a display having border light-emitting elements and tested the border light-emitting elements and determined that the use of such border light-emitting elements is acceptable under a wide range of illuminations and scene contents.

In this test, applicants have determined that a level of 5% of the maximum brightness of a series of scenes provides useful burn-in prevention and is acceptable to viewers. Moreover, a level of up to 20% is also acceptable, particularly in bright ambient illumination conditions and for applications requiring a brighter display. However, since most content is not that bright, on average, a level of between 10% and 15% may be optimal for some applications. Moreover, the brightness may be dependent on the average ambient illumination incident on the display, thereby employing greater accommodation under conditions where user objections may be reduced. For example, the internal aging signal luminance may be increased as the average ambient illumination incident on the display increases.

By moving the location of the subset within the display 10, the edges separating areas having different light-output efficiency will become blurred, making them much less visible. Lower frequency structures within a scene are much less visible than higher-frequency structures. As illustrated in the Figures, the external image signal 18 may be desirably located in the approximate center of the display to provide a pleasing viewing experience. Hence, the location changes of the subset of light-emitting elements driven by the external display signal 18 in the array of OLED light-emitting display elements 12 over time may be greater in one dimension than the other. For example, in the configuration of FIG. 3B, a standard-definition format signal is displayed on an HDTV display and the location changes of the subset is greater in the horizontal dimension than in the vertical dimension. Since the borders 42b on either side of the subset 32 are much larger than the borders 42a above and below the subset 32, there is plenty of room to move the subset a greater distance, thereby reducing the frequency of any vertical structures in the scene that result from unequal usage and providing a pleasing, centered viewing experience. In particular, since most television displays sold today employ a high-definition 16:9 aspect ratio, the configuration of FIG. 3B is frequently found and the borders on the sides would be unequally aged due to presenting different format content. Hence, moving the subset horizontally may be very helpful in mitigating the format difference problem. Hence, the external image signal may have an aspect ratio that is relatively larger than the display aspect ratio, and the location changes of the subset is greater in the vertical dimension than in the horizontal dimension. Alternatively, the external image signal has an aspect ratio that is relatively smaller than the display aspect ratio, and the location changes of the subset is greater in the horizontal dimension than in the vertical dimension.

Ideally, for maximum effect in reducing differential aging, the external image signal 18 would be moved all the way to either vertical edge on a high-definition receiver; however, to maintain an approximately centered image, viewers may not prefer to see the signal displayed all the way to the edges and an internal aging signal on only one side of the external image signal (hence the use of limits 44). Alternatively, a high-definition format signal on a standard-definition display may employ greater movement in the vertical dimension (not shown). In alternative embodiments, external image signal may be displayed to the edges of the display and cropped in one dimension.

In a further embodiment of the present invention, the light-emitting elements of the display form pixels, each pixel emitting four different colors of light and having four sub-pixels that each emit one of red, green, blue, and a broadband light. Such a display may be known as an RGBW display. In this case, a variety of signals may be employed to drive the four sub-pixels to achieve a similar color and brightness. However, in order to age such pixels on the borders of the display, it is necessary to drive each of the sub-pixel colors at a level corresponding to the relative average usage of the sub-pixels, rather than the average color or brightness of the pixel itself. This is defined by the controller and typically depends on the rendering algorithm employed to convert an RGB color signal to an RGBW signal. In one case, the W (broadband) pixel is driven to the maximum neutral brightness possible (a white mixing ratio of one). In this case, the W sub-pixel is effectively driven to the neutral luminance signal and the remaining color sub-pixels driven to the color signal. In an alternative case, only some of the neutral luminance signal is represented by the W sub-pixel, and the remainder of the signal stays with the color sub-pixels. For example, to minimize differential aging, if a gray color is the average pixel color, the gray color should not be rendered by driving the white sub-pixel alone, but rather with a combination of all four sub-pixels. In any case, the sub-pixels in the border area should be driven at a level corresponding to their relative use prescribed by the rendering algorithm.

In a preferred embodiment of the present invention, the sub-pixels preferably age at a common rate with respect to the other border pixels and also with those pixels in the non-border area. This may be accomplished, for example, by driving the sub-pixels at a common current density. Alternatively, if the materials in the sub-pixels age at different rates in response to current passing through the materials, different currents may be employed for materials having different aging rates. The currents may be chosen so that the broadband light-emitting sub-pixel and the red, green, and blue sub-pixels have a common lifetime.

It is known to employ amorphous silicon driving circuitry with each sub-pixel. Since the amorphous silicon materials also experience aging in the form of changes in their threshold voltage response, the present invention may be employed to reduce such performance differences in the transistors employed in the display elements subset and border areas of a display. By controlling and equalizing the total current passing through the sub-pixel circuitry, such performance differences may be reduced.

The present invention can be constructed simply, requiring only a conventional display controller with some additional circuitry for creating an internal aging signal and combining it with an existing input signal. Such circuitry is well known in the art and may comprise, for example, an analog-to-digital convertor (for analog input signals), a frame store, logic for writing data into the frame store and for reading data from the frame store and processing it, a clock, and some non-volatile memory.

Testing completed by applicant has demonstrated that flat-panel devices are typically hotter in the center than at the edges. Since OLED materials tend to age faster in the presence of heat, it may be preferred to over compensate pixels in the borders to age the border pixels at a rate comparable to the typically hotter pixels driven by the external image signal. The extent of over-compensation may be dynamically controlled by measuring the temperature of the display and matching the compensation to the temperature measurement.

In a preferred embodiment, the invention is employed in a device that includes Organic Light-emitting Diodes (OLEDs) which are composed of small molecule or polymeric OLEDs as disclosed in but not limited to U.S. Pat. No. 4,769,292, issued Sep. 6, 1988 to Tang et al., and U.S. Pat. No. 5,061,569, issued Oct. 29, 1991 to VanSlyke et al. Many combinations and variations of organic light-emitting displays can be used to fabricate such a device. In other embodiments, the present invention is employed in plasma display devices.

The present invention can be employed in most OLED device configurations. These include very simple structures comprising a single anode and cathode to more complex devices, such as passive matrix displays comprised of orthogonal arrays of anodes and cathodes to form light-emitting elements, and active-matrix displays where each light-emitting element is controlled independently, for example, with thin film transistors (TFTs). It may be employed in both top- and bottom-emitter configurations.

The invention has been described in detail with particular reference to certain preferred embodiments thereof, but it will be understood that variations and modifications can be effected within the spirit and scope of the invention.

### PARTS LIST

10 OLED display
12 light-emitting elements
16 controller
18 external image signal
19 internal display aging signal
20 composite image signal
30, 30′ 16:9 aspect ratio subset of light-emitting elements
32, 32′ 4:3 aspect ratio subset of light-emitting elements
40a, 40b border of light-emitting elements
42a, 42b border of light-emitting elements
44a, 44b limit
100 display
102 display
104 region
105 region
106 region
107 region
200 provide external image signal step
202 provide display step
204 drive display with composite signal step
206 digitize external image signal step
208 store digitized external image signal step
210 form internal aging signal step
212 form composite signal step
214 read composite signal step
220 change location step

What is claimed is:

1. A method of driving an OLED display having a plurality of light-emitting display elements having outputs that change with time or use, comprising the steps of:
a) providing an external image signal with a first image aspect ratio;
b) providing an OLED display having light-emitting display elements formed in a two-dimensional array having a second display aspect ratio different from the first image aspect ratio;
c) driving all of the two-dimensional array of display elements with a composite signal comprising the external image signal and an internal aging signal, wherein a subset of the display elements is driven by the external image signal and the remainder of the display elements that are not driven by the external image signal are driven with the internal aging signal; and
d) changing the location of the subset of display elements within the two-dimensional array driven by the external image signal over time.

2. The method of claim 1, wherein the number of display elements in the subset of the display elements is smaller than the number of display elements in each dimension of the two-dimensional array of display elements.

3. The method of claim 1, wherein the number of light-emitting elements in the two-dimensional array is larger than the number of image elements in each corresponding dimension of the external image signal.

4. The method of claim 1, wherein the internal aging signal has a luminance value from 10-90% of the average luminance value of the external image signal over time.

5. The method of claim 1, wherein the internal aging signal has a luminance value from 25-75% of the average luminance value of the external image signal over time.

6. The method of claim 1, wherein the internal aging signal has a luminance value approximately 50% of the average luminance value of the external image signal over time.

7. The method of claim 1 wherein the internal aging signal depends on the relative amount of time that the light-emitting elements are driven with the external image signal or on the average luminance of the external image signal over time.

8. The method of claim 1 wherein the internal aging signal depends on the average luminance of a portion of the external image signal over time.

9. The method of claim 8 wherein the internal aging signal depends on the average luminance at or near an edge of the external image signal.

10. The method of claim 8 wherein the internal aging signal depends on the smaller of the average luminance at or near an edge of the external image signal and the average luminance of the external image signal over time.

11. The method of claim 1 wherein the internal aging signal depends on the average ambient illumination incident on the display.

12. The method of claim 11 wherein the internal aging signal luminance is increased as the average ambient illumination incident on the display increases.

13. The method of claim 1 wherein the internal aging signal has a luminance value of 5% to 20% of the maximum luminance of the display.

14. The method of claim 1 wherein the internal aging signal has a luminance value of 10% to 15% of the maximum luminance of the display.

15. The method of claim 1 wherein the location of the subset of display elements in the two-dimensional array driven by the external image signal is changed over time relatively greater in one dimension than the other.

16. The method of claim 1 wherein the location changes are limited in a dimension to less than the total number of light-emitting elements in that dimension.

17. The method of claim 1 wherein the external image signal has an aspect ratio that is relatively larger than the display aspect ratio, and the location changes of the subset is greater in the vertical dimension than in the horizontal dimension.

18. The method of claim 1 wherein the external image signal has an aspect ratio that is relatively smaller than the display aspect ratio, and the location changes of the subset is greater in the horizontal dimension than in the vertical dimension.

19. The method of claim 1 wherein the light-emitting elements form pixels, each pixel emitting four different colors of light and having four sub-pixels that each emit one of red, green, blue, and a broadband light, and the internal aging signal drives both the broadband light-emitting sub-pixel and the red, green, and blue sub-pixels at a level corresponding to the relative average usage of the sub-pixels.

20. An OLED display comprising
a) a plurality of light-emitting display elements having outputs that change with time or use, formed in a two-dimensional array having a display aspect ratio; and
b) a controller for receiving an external image signal with an image aspect ratio different from the display aspect ratio; for driving all of the two-dimensional array of display elements with a composite signal comprising the external image signal and an internal aging signal, wherein a subset of the display elements is driven by the external image signal and the remainder of the display elements that are not driven by the external image signal are driven with the internal aging signal; and for changing the location of the subset of display elements within the two-dimensional array driven by the external image signal over time.
